(19) United States
(12) Patent Application Publication
(10) Pub. No.: US 2012/0268497 A1
(43) Pub. Date: Oct. 25, 2012

(54) DEVICE AND METHOD FOR ARRANGING OBJECT

(75) Inventors: Young-Ki AHN, Seoul (KR); Kyoung-Yong Lee, Suwon-si (KR)

(73) Assignee: Samsung Electronics Co., Ltd., Gyeonggi-do (KR)

(21) Appl. No.: 13/451,122

(22) Filed: Apr. 19, 2012

Related U.S. Application Data
(60) Provisional application No. 61/477,012, filed on Apr. 19, 2011.

(30) Foreign Application Priority Data
Apr. 13, 2012 (KR) 10-2012-0038291

(51) Int. Cl. G09G 5/00

(52) U.S. Cl. 345/666

(57) ABSTRACT

A device for arranging objects is provided. The device includes a display unit for displaying a plurality of objects having a relationship set between corresponding sides of the plurality of objects; and a control unit for designating at least one of a location and a size of each of the plurality of objects according to the relationship set between the corresponding sides, and for changing, when at least one of a location and size of a specific object from among the plurality of objects is changed, at least one of a location and a size of at least one other object having a relationship set with regard to a side of the specific object.

### PRIORITY

This application claims priority under 35 U.S.C. §119(a) to a U.S. Provisional Patent Application Ser. No. 61/477,012, which was filed in the USPTO on Apr. 19, 2011, and Korean Patent Application Serial No. 10-2012-0038291, which was filed in Korean Intellectual Property Office on Apr. 13, 2012, the entire contents of each of which are incorporated herein by reference.

### BACKGROUND OF THE INVENTION

1. Field of the Invention

The present invention relates generally to a device and a method for arranging objects, and more particularly to a device and a method for easily arranging Graphical User Interface objects at various resolutions.

2. Description of the Related Art

In a Graphical User Interface (GUI), positioning of a GUI object on the screen requires location information and size information. Methods for specifying the location and size information regarding GUI objects include methods based on detailing numerical values. Such methods require that, when applied at various resolutions, the numerical values are transformed directly at each resolution.

Another method for specifying the location and size information regarding GUI objects uses a logical tool ‘anchor’ to interconnect GUI objects. According to this method, when one of a group of GUI objects connected to each other by a same anchor is changed, the other GUI objects in the group react to that change.

However, in the anchor-based method, the virtual tool ‘anchor’ makes it difficult for users to intuitively create variously changed patterns.

In another method for specifying the location and size information regarding GUI objects, GUI objects use an align attribute to designate corresponding sides between GUI objects. This method also adopts such a structure that, when one of GUI objects is changed, the other GUI object reacts to that change. However, the align attribute-based method has a problem in that the method employs many (at least fifteen) align attributes, and therefore, users find the method to be overly complicated.

### SUMMARY OF THE INVENTION

Accordingly, the present invention has been made to solve the above-stated problems occurring in the prior art, and the present invention provides a device and a method for easily arranging GUI objects at various resolutions.

Further, the present invention provides a device and a method capable of designating the location and/or size of GUI objects solely by setting a relationship between sides of the GUI objects.

In accordance with an aspect of the present invention, a device for arranging objects is provided. The device includes a display unit for displaying a plurality of objects having a relationship set between corresponding sides of the plurality of objects; and a control unit for designating at least one of a location and a size of each of the plurality of objects according to the relationship set between the corresponding sides, and for changing, when at least one of a location and size of a specific object from among the plurality of objects is changed, at least one of a location and a size of at least one other object having a relationship set with regard to a side of the specific object.

In accordance with another aspect of the present invention, a method for arranging objects is provided. The method includes designating, when a relationship regarding corresponding sides of a plurality of objects is set, at least one of a size and a location of each of the plurality of objects based on the set relationship; and changing, when at least one of a size and location of a specific object from among the plurality of objects is changed, at least one of a location and a size of at least one other object that has a relationship set with regard to at least one side of the specific object.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating a construction of a portable terminal according to an embodiment of the present invention;

FIG. 2 is a flowchart illustrating a process of arranging objects according to an embodiment of the present invention;

FIG. 3 is a diagram illustrating an object relationship setup according to an embodiment of the present invention;

FIGS. 4A to 4F are diagrams illustrating an object relationship setup according to another embodiment of the present invention; and

FIG. 5 is a diagram illustrating a data structure in connection with object relationship setup.

### DETAILED DESCRIPTION OF EMBODIMENTS OF THE PRESENT INVENTION

Hereinafter, embodiments of the present invention are described in detail with reference to the accompanying drawings. Throughout the drawings, the same or similar elements may be indicated by the same reference. In the following description, specific details such as detailed configuration and components are merely provided to assist the overall understanding of embodiments of the present invention. Therefore, it should be apparent to those skilled in the art that various changes and modifications of the embodiments described herein can be made without departing from the scope and spirit of the invention. In addition, descriptions of well-known functions and constructions may be omitted for clarity and conciseness.

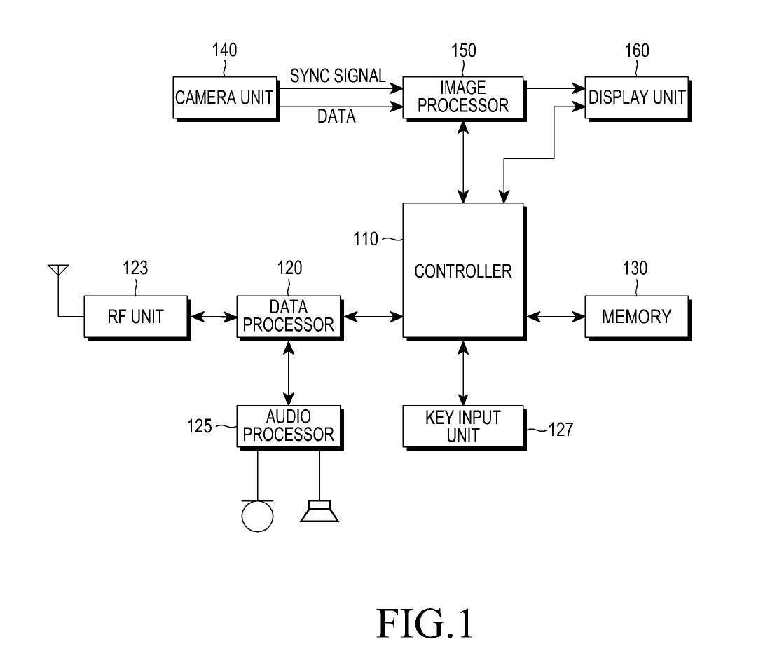

FIG. 1 illustrates a construction of a portable terminal according to an embodiment of the present invention.

Referring to FIG. 1, a Radio Frequency (RF) unit 123 performs a wireless communication function of the portable terminal. The RF unit 123 includes an RF transmitter (not shown) adapted to up-convert and amplify the frequency of transmitted signals and a RF receiver (not shown) adapted to low-noise-amplify received signals and down-convert the frequency. A data processing unit 120 includes a transmitter (not shown) that encodes and modulates the transmitted signals and a receiver that decodes and demodulates the received signals. Specifically, the data processing unit 120 may include of a modem and a codec. The codec, in this case, includes a data codec for processing packet data, etc., and an audio codec for processing audio signals (e.g., voice signals). An audio processing unit 125 reproduces received audio signals that are output from the audio codec of the data processing unit 120 and delivers audio signals to be transmitted, which are generated from a microphone, to the audio codec of the data processing unit 120.

A key input unit 127 includes keys for inputting numeric and character information and function keys for setting various functions.

A memory 130 may include program memories and data memories (not shown). The program memories store programs for controlling normal operations of the portable terminal, as well as programs for setting a relationship between sides of GUI objects and, when the location and/or size of a specific GUI object is varied, changing the location and/or size of at least one GUI object, which has a relationship set with the former, according to an embodiment of the present invention. The data memories temporarily store data generated while the programs are being executed.

The memory 130 stores information on sides of at least one GUI object, which have a relationship set to correspond to respective sides of a specific GUI object, in order to arrange a plurality of GUI objects according to an embodiment of the present invention.

A control unit 110 controls the overall operation of the portable terminal. The control unit 110 designates the location and/or size of each of a plurality of objects, which have a relationship set regarding their corresponding sides, according to an embodiment of the present invention.

When a relationship is set to associate each side of a target object with a side of at least one object, the location and/or size of which has been designated, in an object relationship setup mode, the control unit 110 designates the location and/or size of the target object based on the relationship setup according to an embodiment of the present invention.

When first to fourth objects are arranged, the control unit 110 designates the location and/or size of the first object to arrange the second to fourth objects, and, when a relationship is set to associate some sides of the second object with at least one side of the first object, the control unit 110 designates the location and/or size of the second object. For example, when a relationship is set to associate the upper and left sides of the second object with the upper and left sides of the first object, respectively, the control unit 110 can designate the location and/size of the second object.

When a relationship is set to associate some sides of the third object with at least one of the sides of the first and second objects, the control unit 110 designates the location and/or size of the third object. For example, when a relationship is set to associate the left, lower, and right sides of the third object with the left, lower, and right sides of the first object, respectively, the control unit 110 can designate the location and/size of the third object.

When a relationship is set to associate some sides of the fourth object with at least one of the sides of the first to third objects, the control unit 110 designates the location and/or size of the fourth object. For example, when a relationship is set to associate the left side of the fourth object with the left side of the first object, associate the upper and right sides of the fourth object with the lower and right sides of the second object, respectively, and associate the lower side of the fourth object with the upper side of the third object, the control unit 110 can designate the location and/size of the fourth object.

When a relationship regarding corresponding sides of the plurality of objects is set, the control unit 110 designates the interval between sides according to an embodiment of the present invention.

In an object relationship release mode, the control unit 110 releases a relationship set between at least one object and surfaces selected from respective surfaces of a specific one of the plurality of objects, according to an embodiment of the present invention.

When a specific one of the plurality of objects is varied, the control unit 110 changes the location and/or size of at least one object, which has a relationship set with regard to respective surfaces of the specific object, according to an embodiment of the present invention.

When a specific one of the plurality of objects is varied, the control unit 110 calculates and changes the location and/or size of at least one object, which has a relationship set to correspond to respective surfaces of the specific object, is calculated and changed, and the location and/or size of at least one object, which has a relationship set with regard to respective surfaces of the at least one changed object, according to an embodiment of the present invention.

When a relationship regarding sides of first to fourth objects is set to arrange these objects, and when the location and/or size of a specific one of the first to fourth objects is varied, the control unit 110 calculates and changes the location and/or size of at least one object, which has a relationship set with regard to respective sides of the specific object, according to an embodiment of the present invention. For example, when the vertical size of the first object, which is used to arrange the second to fourth objects among the first to fourth objects, is reduced, the control unit 110 can move the location of the third object, which has a relationship set with the first object to have correspondence between their lower sides, upwards and reduce the vertical size of the fourth object, which has a relationship set to correspond to the upper side of the third object. Alternatively, when the horizontal size of the first object, which is used to arrange the second to fourth objects among the first to fourth objects, is reduced, the control unit 110 can reduce the horizontal size of the third object, which has a relationship set with the first object to have correspondence between their left and right sides.

Referring back to FIG. 1, a camera unit 140 includes a camera sensor (not shown) adapted to take image data and convert the obtained optical signals into electric signals and a signal processing unit adapted to convert analog image signals, which have been taken by the camera sensor, into digital data. The camera sensor may be any of various types of camera sensors including a Charge-Coupled Device (CCD) or a Complementary Metal-Oxide-Semiconductor (CMOS) sensor, and the signal processing unit may be implemented as a Digital Signal Processor (DSP), for example. The camera sensor and the signal processing unit may be implemented as an integral unit or as separate units.

The image processing unit 150 performs Image Signal Processing (ISP) for displaying image signals that are output from the camera unit 140, through the display unit 160. The ISP performs functions such as gamma correction, interpolation, spatial change, image effects, image scaling, Auto White Balance (AWB), Auto Exposure (AE), Auto Focus (AF), etc. The image processing unit 150 processes image signals that are output from the camera unit 140, on a frame-by-frame basis, and outputs the frame image data in conformity with the characteristics and size of the display unit 160. The image processing unit 150 has an image codec (not shown) that compresses frame image data that is displayed by the display unit 160, in a predetermined scheme or restore compressed frame image data into original frame image data. The image codec in this case may be a Joint Photographic Experts Group (JPEG) codec, a Motion Picture Experts Group 4 (MPEG4) codec, a Wavelet codec, etc. The image processing unit 150 may have an On Screen Display (OSD) function and may output OSD data in conformity with the screen size determined under the control of the control unit 110.

A display unit 160 displays image signals output from the image processing unit 150, on the screen. The display unit 160 also displays user data output from the control unit 110. The display unit 160 may be a Liquid Crystal Display (LCD) and, in this case, the display unit 160 may include an LCD controller, a memory for storing image data, an LCD display device, etc. When the LCD is a touch screen display, the LCD can also function as an input unit. In this case, the display unit 160 can display keys comparable to those corresponding to the key input unit 127.

The display unit 160 displays a plurality of objects have a relationship set with regard to their sides, according to an embodiment of the present invention.

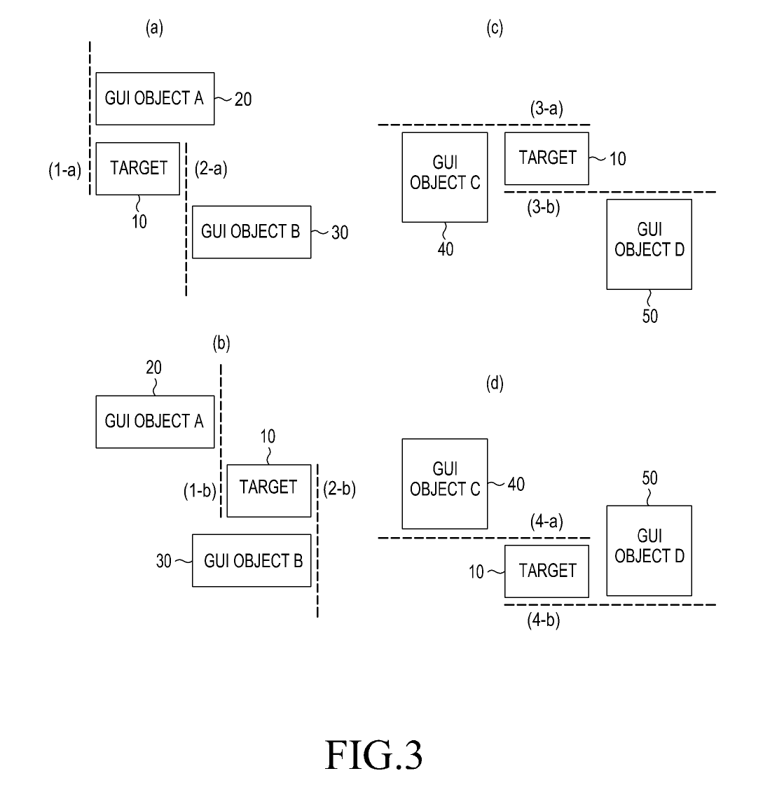

Operations for arranging objects by the above-mentioned portable terminal are described in detail as follows with reference to FIGS. 3-5.

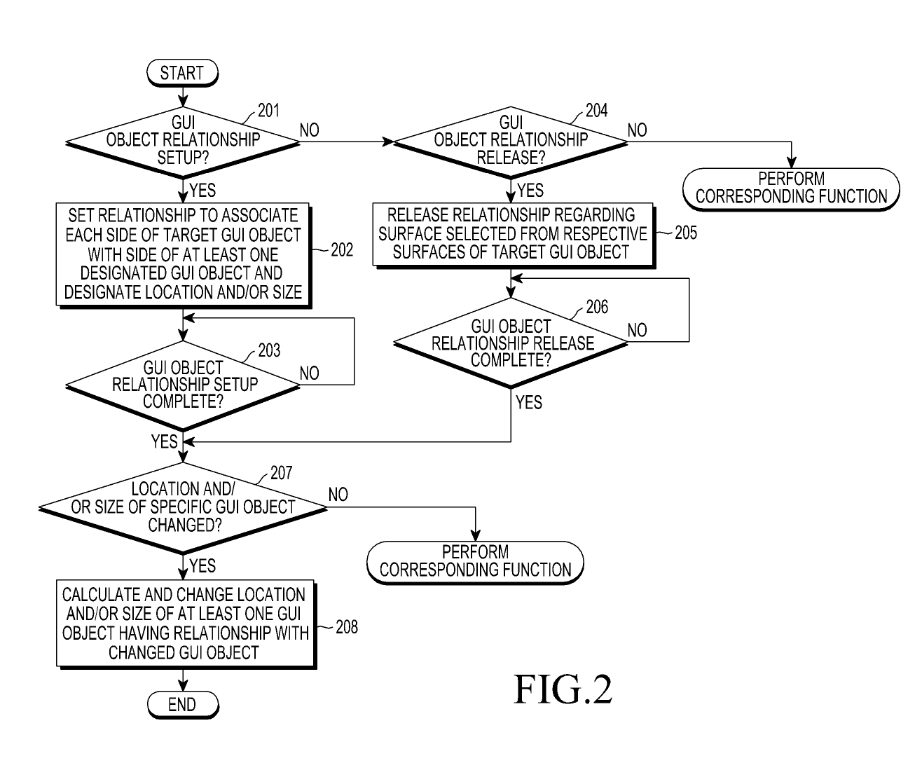

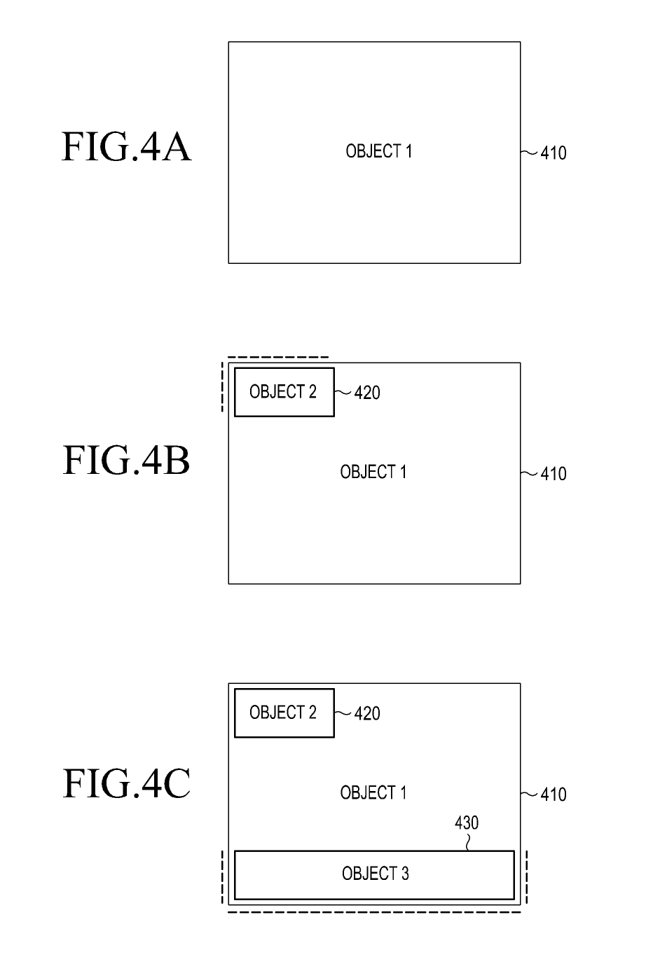

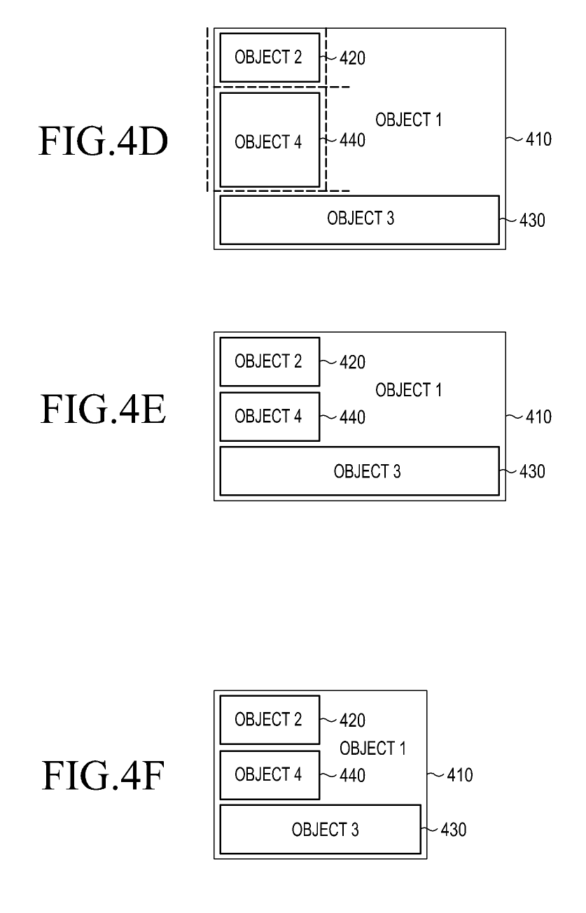

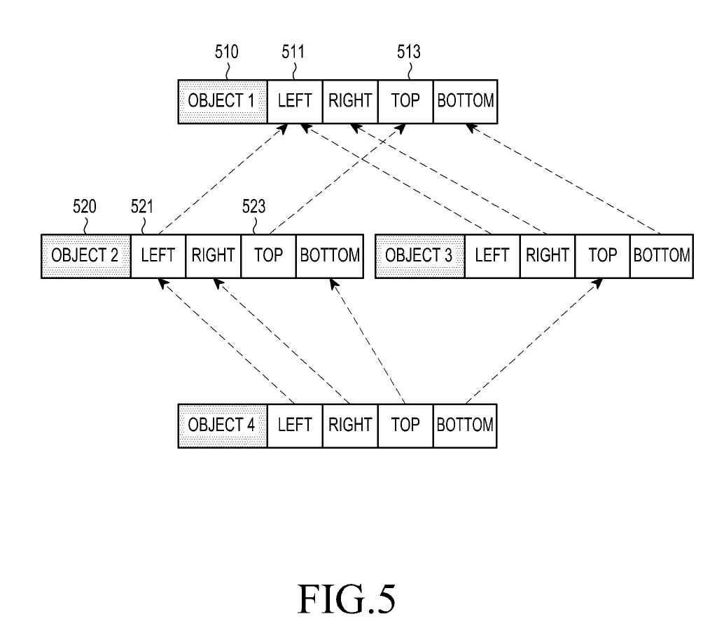

FIG. 2 is a flowchart illustrating a process of arranging objects according to an embodiment of the present invention. FIG. 3 is a diagram illustrating object relationship setups according to an embodiment of the present invention. FIGS. 4A to 4F are diagrams illustrating object relationship setups according to another embodiment of the present invention. FIG. 5 is a diagram illustrating a data structure in connection with object relationship setup shown in FIGS. 4A to 4F.

Referring to FIG. 2, when a GUI object relationship setup mode is selected in step 201, the control unit 110 detects the selection and switches the portable terminal to the GUI object relationship setup mode.

When the user sets a relationship between sides of a plurality of objects in the GUI object relationship setup mode, the control unit 110 proceeds to step 202 to designate the location and/or size of each of the plurality of objects based on the relationship setup.

When the user sets the location and/or size of a target GUI object by setting a relationship to associate each side of the target GUI object with a corresponding side of at least one other GUI object, the location and/or size of which has already been designated, in step 202, the control unit 110 designates the location and/or size of the target GUI object according to the previously designated location and/or size of the at least one other GUI object.

In the examples shown in FIG. 3, the location and/or size of GUI objects A-D has already been designated in step S202. When the location and/or size of a target GUI object is to be set, the user can associate the left side of the target GUI object 10 with the left side of GUI object A 20 along line 1-a, as shown in FIG. 3(a), or can alternatively be associated with the right side of GUI object A 20 designated by line 1-b, as shown in FIG. 3(b). The user can also associate the right side of the target GUI object 10 with the left side of GUI object B 30 designated by line 1-b, as shown in FIG. 3(a), or can alternatively be associated with the right side of GUI object B 30 designated by line 2-b, as shown in FIG. 3(b).

Alternatively, the user can associate the upper side of the target GUI object 10 with the upper side of GUI object C 40 designated by line 3-a, as shown in FIG. 3(c), or can alternatively be designated with the lower side of GUI object C 40 designated by line 4-a, as shown in FIG. 4(d). The user can also associate the lower side of the target GUI object 10 with the upper side of GUI object D 50 designated by line 3-b, as shown in FIG. 3(c), or can alternatively be associated with the lower side of GUI object D 50 designated by line 4-b, as shown in FIG. 3(d). When the user associates a side of the target GUI object with a side of at least one of GUI objects A-D in this manner, the user can set a value for the interval between the two sides.

After the user sets the location and/or size of the target GUI object as described above, the control unit 110 designates the location and/or size of the target GUI object based on the relationship set between sides of the target GUI object and GUI objects A-D.

Referring back to FIG. 2, when designation of the location and/or size of the plurality of objects is completed in step 202, the control unit 110 detects the completion in step 203 and ends the GUI object relationship setup mode.

If a user selects not to perform a GUI object relationship setup in step 201, the controller 110 proceeds to step 204. In step 204, when a GUI object relationship release is selected, the control unit 110 detects the selection, switches to a GUI object relationship release mode, and proceeds to step 205. In step 205, in the GUI object relationship release mode, when the user selects a target GUI object from a plurality of GUI objects, which have a relationship set between their sides, and when the user selects a specific side from sides of the selected specific GUI object, the relationship set between the selected side and the side of the at least one GUI object is released.

When the GUI object relationship release termination is selected in step 206, the control unit 110 terminates the GUI object relationship release and proceeds to step 207.

In step 207, when the location and/or size of a specific GUI object is varied while the display unit 160 displays a plurality of objects that have a relationship set between their sides as described above, the control unit 110 proceeds to step S208 where the location and/or size of at least one GUI object having the relationship set with the varied specific GUI object with regard to respective sides, is calculated and changed.

Operations for designating the location and/or size of a plurality of GUI objects based on side relationship setup in FIG. 2, as well as operations for changing the location and/or size of a plurality of objects based on side relationship setup, are described as follows with reference to examples shown in FIGS. 4A to 4F.

Referring to FIG. 4A, the user designates a first object 410 that is used to display a plurality of GUI objects. After selecting the first object 410, the user sets a relationship to associate the left and upper sides of a second object 420 with the left and upper sides of the first object 410, respectively, as shown in FIG. 4B. The user also sets a relationship to associate the left, lower, and right sides of a third object 430 with the left, lower, and right sides of the first object 410, respectively, as shown in FIG. 4C.

As shown in FIG. 4D, the user also sets a relationship to associate the left side of a fourth object 440 with the left side of the first object 410, associate the upper and right sides of the fourth object 440 with the lower and right sides of the second object 420, and associate the lower side of the fourth object 440 with the upper side of the third object 430.

After the user sets a relationship between sides of the first to fourth objects 410 to 440 as shown in FIGS. 4A to 4D, the control unit 110 designates the location and/or size of each object based on the relationship setup.

For example, when the location and/or size of each of the first to fourth objects 410 to 440 is designated to display these objects on the display unit 160 as shown in FIG. 4D, and when the vertical size of the first object is reduced, the control unit 110 moves the location of the third object 430, which has a relationship set to correspond to the lower side of the first object 410, upwards, reduces the vertical size of the fourth object 440, which has a relationship set to correspond to the upper side of the third object 430, and displays these objects as shown in FIG. 4E.

That is, as shown in FIG. 4E, the lower side of the fourth object 440 is associated with the third object 430, and the lower side of the third object 430 is then associated with the first object 410, meaning that change of the vertical size of the first object 410 alone varies the location of the third object 430 and the size of the fourth object 440.

When the horizontal size of the first object 410 as shown in FIG. 4E is reduced, the control unit 110 reduces the horizontal size of the third object 430, which has a relationship set to correspond to the left and right sides of the first object 410, and displays these objects as shown in FIG. 4F.

As shown in FIG. 4F, change of the horizontal size of the first object 410 is followed by change of the horizontal size of the third object 430, which has a relationship set with the right side of the first object 410.

FIG. 5 illustrates a data structure in connection with a relationship set among first to fourth objects 410 to 440, as described with reference to FIG. 4. In the data structure shown in FIG. 5, relationships regarding the four sides of each GUI object are designated, such that the arrows point to the references. For example, the “LEFT” and “TOP” elements 521 and 523 corresponding to second data object 520 (which corresponds to second object 420) point towards the “LEFT” and “TOP” elements 511 and 513 corresponding to first data object 510 (which corresponds to first object 410), such as shown and described with reference to FIG. 4B.

If designations of side relationship have a cyclic structure, such a designation may result in endless repetition. However, the in a data structure according to embodiments of the present invention, such as the example shown in FIG. 5, enables instant recognition (by either the user, the device performing the operation, or both) of whether relationship designations lead to a cyclic structure, and thus avoids the problem of endless repetition.

The device and method for arranging objects according to embodiments of the present invention are advantageous in that, through setting a relationship between respective sides of the objects, users can arrange GUI objects in a more convenient and intuitive manner.

Device and methods for arranging objects according to embodiments of the present invention can be implemented as computer-readable codes on a computer-readable recording medium. As used herein, the computer-readable recording medium includes all types of recording devices storing data that can be read by computer systems. Examples of the recording medium include Read-Only Memory (ROM), Random Access Memory (RAM), optical disks, magnetic tape, floppy disks, hard disks, nonvolatile memories, etc. Such implementations may also involve carrier waves (e.g., transmission via Internet). The computer-readable recording medium can also store and execute codes that are distributed over computer systems connected via networks and that can be read by computers in a distributed manner.

While the present invention has been shown and described with reference to certain embodiments and drawings thereof, it will be understood by those skilled in the art that various changes in form and details may be made therein without departing from the spirit and scope of the invention as defined by the appended claims.

What is claimed is:

1. A device for arranging objects, comprising:
a display unit for displaying a plurality of objects having a relationship set between corresponding sides of the plurality of objects; and
a control unit for designating at least one of a location and a size of each of the plurality of objects according to the relationship set between the corresponding sides, and for changing, when at least one of a location and size of a specific object from among the plurality of objects is changed, at least one of a location and a size of at least one other object having a relationship set with regard to a side of the specific object.

2. The device as claimed in claim 1, wherein, when a target relationship is set in an object relationship setup mode to associate at least one side of a target object with at least one side of at least one non-target object, a location and/or a size of which has been designated, the control unit designates at least one of a location and a size of the target object based on the set target relationship.

3. The device as claimed in claim 1, wherein the plurality of objects includes a first object, a second object, a third object, and a fourth object,
wherein the control unit designates an arrangement of the second, third, and fourth objects according to an arrangement of the first object,
wherein the control unit designates at least one of a location and a size of the second object according to a relationship set to associate at least one side of the second object with at least one side of the first object,
wherein, the control unit designates at least one of a location and a size of the third object according to a relationship set to associate at least one side of the third object with at least one side of each of the first and second objects, and
wherein the control unit designates at least one of a location and a size of the fourth object according to the at least one side of each of the first, second, and third objects according to a relationship is set to associate at least one side of the fourth object with at least on side of each of the first, second, and third objects.

4. The device as claimed in claim 3, wherein the control unit designates at least one of the location and size of the second object according to a relationship set to associate upper and left sides of the second object with upper and left sides of the first object, respectively;
wherein the control unit designates at least one of the location and size of the third object according to a relationship set to associate left, lower, and right sides of the third object with left, lower, and right sides of the first object, respectively, and
wherein the control unit designates at least one of the location and size of the fourth object according to a relationship set to associate a left side of the fourth object with a left side of the first object, associate upper and right sides of the fourth object with lower and right sides of the second object, respectively, and associate a lower side of the fourth object with an upper side of the third object.

5. The device as claimed in claim 1, wherein the control unit sets, when an interval relationship is set between the plurality of objects regarding corresponding sides of the plurality of objects, an interval between the corresponding sides according to the set interval relationship.

6. The device as claimed in claim 1, wherein the control unit releases, in an object relationship release mode, a relationship with a specific side of a selected object from among the plurality of objects and at least one other object that has a relationship set with the selected side

7. The device as claimed in claim 1, wherein, when the at least one of the location and size of the at least one other object is changed, the control unit calculates and changes, and at least one of a location and a size of at least one related object that has a relationship set with regard to at least one side of the at least one changed object.

8. The device as claimed in claim 1, wherein the plurality of objects includes a first object, a second object, a third object, and a fourth object, and
wherein, the control unit calculates and changes, when the first, second, third, and fourth objects are arranged based on a relationship between their sides and at least one of a location and a size of a first particular object from among the first, second, third, and fourth objects is changed, a location and/or a size of at least one other particular object that has a relationship set with regard to at least one side of the first particular object.

9. The device as claimed in claim 8, wherein a vertical size of the first object is used to arrange the second, third, and fourth object,
a location of the third object has a relationship set to correspond to a lower side of the first object, and wherein a vertical size of the fourth object has a relationship set to correspond to an upper side of the third object,
wherein when the vertical size of the first object is reduced, the control unit moves the location of the third object upwards and reduces the vertical size of the fourth object.

10. The device as claimed in claim 8, wherein a horizontal size of the first object is used to arrange the second, third, and fourth objects, and a horizontal size of the third object has a relationship set to correspond to the left and right sides of the first object
wherein, when the horizontal size of the first object is reduced, the control unit reduces the horizontal size of the third object.

11. A method for arranging objects, comprising the steps of:
designating, when a relationship regarding corresponding sides of a plurality of objects is set, at least one of a size and a location of each of the plurality of objects based on the set relationship; and
changing, when at least one of a size and location of a specific object from among the plurality of objects is changed, at least one of a location and a size of at least one other object that has a relationship set with regard to at least one side of the specific object.

12. The method as claimed in claim 11, wherein designating the at least one of the size and location of each of the plurality of objects comprises:
selecting a target object in an object relationship setup mode; and
designating, when a target relationship is set to associate at least one side of the target object with at least one side of at least one non-target object, a location and/or a size of which has been designated, a location and/or a size of the target object based on the set target relationship.

13. The method as claimed in claim 11, wherein the plurality of objects includes a first object, a second object, a third object, and a fourth object, and
wherein designating the at least one of the size and location of each of the plurality of objects comprises:
designating an arrangement of the second, third, and fourth objects according to an arrangement of the first object;
designating at least one of a location and a size of the second object according to a relationship set to associate at least one side of the second object with at least one side of the first object;
designating at least one of a location and a size of the third object according to a relationship set to associate at least one side of the third object with at least one side of each of the first and second objects; and
designating at least one of a location and a size of the fourth object according to a relationship set to associate at least one side of the fourth object with at least one side of each of the first, second, and third objects.

14. The method as claimed in claim 13, further comprising:
designating at least one of a location and a size of the second object according to a relationship set to associate upper and left sides of the second object with upper and left sides of the first object, respectively;
designating at least one of a location and a size of the third object according to a relationship set to associate left, lower, and right sides of the third object with left, lower, and right sides of the first object, respectively; and
designating at least one of a location and a size of the fourth object according to a relationship set to associate a left side of the fourth object with a left side of the first object, associate upper and right sides of the fourth object with lower and right sides of the second object, respectively, and associate a lower side of the fourth object with an upper side of the third object.

15. The method as claimed in claim 11, wherein designating the at least one of the size and location of each of the plurality of objects includes setting, when an interval relationship is set between the plurality of objects regarding corresponding sides of the plurality of objects, an interval between the corresponding sides according to set the interval relationship.

16. The method as claimed in claim 11, further comprising releasing, when a specific side of a selected object from among the plurality of objects is selected in an object relationship release mode, a relationship set with the selected side and at least one other object that has a relationship set with the selected side.

17. The method as claimed in claim 11, further comprising:
determining at least one related object that has a relationship set with regard to at least one side of the at least one changed object; and
calculating and changing at least one of a location and a size of the at least one related object according to the relationship set with regard to the at least one related object and the at least one side of the at least one changed object.

18. The method as claimed in claim 11, wherein the plurality of objects includes first, second, third, and fourth objects, and
wherein changing the at least one of the size and location of the at least one other comprises:
determining, when the first, second, third, and fourth objects are arranged based on a relationship between their sides and at least one of a location and a size of a first particular object from among the first, second, third, and fourth objects changes, at least one other particular object that has a relationship set with regard to at least one side of the particular object; and
calculating and changing a location and/or a size of the at least one other particular object according to the relationship set with the at least one side of the first particular object.

19. The method as claimed in claim 18, wherein the third object has a relationship set to correspond to a lower side of the first object and the fourth object has a relationship set to correspond to an upper side of the third object, and
wherein the method further comprises moving, when a vertical size of the first object is reduced, a location of the third object according to the relationship set to the third object and the first object, upwards and reducing a vertical size of the fourth object according to the relationship set to correspond to the fourth object and the third object.

20. The method as claimed in claim 18, further comprising reducing, when a horizontal size of the first object is reduced, a horizontal size of the third object, which has a relationship set to correspond to the first object with regard to left and right sides.
